(19) United States
(12) Patent Application Publication
(10) Pub. No.: US 2017/0043779 A1
(43) Pub. Date: Feb. 16, 2017

(54) CONTROL METHOD OF VEHICLE

(71) Applicant: HYUNDAI MOTOR COMPANY, Seoul (KR)

(72) Inventor: Young Min YOON, Suwon-si (KR)

(21) Appl. No.: 14/944,120

(22) Filed: Nov. 17, 2015

(30) Foreign Application Priority Data
Aug. 11, 2015 (KR) 10-2015-0112985

(51) Int. Cl. B60W 30/184; B60W 10/11; B60W 10/06

(52) U.S. Cl. CPC B60W 30/1843; B60W 10/06; B60W 10/11; B60W 2510/0291; B60W 2710/0644; B60W 2710/1005

(57) ABSTRACT

A control method for a vehicle includes steps of calculating, by a controller, a clutch severity index based on a clutch temperature distribution, and adjusting, by the controller, at least one of a shift pattern of the transmission and an engine RPM based on the clutch severity index.

### CROSS REFERENCE TO RELATED APPLICATION

The present application claims the benefit of priority to Korean Patent Application Number 10-2015-0112985, filed in the Korean Intellectual Property Office on Aug. 11, 2015, the entirety of which is incorporated herein by reference.

### TECHNICAL FIELD

The present disclosure relates to a control method for a vehicle, and more particularly to a control method for a vehicle capable of preventing overheating of a clutch in a vehicle in which a dry type clutch is mounted.

### BACKGROUND

Double Clutch Transmission (DCT) is a system for automatically controlling a manual transmission, and it delivers engine torque using a dry type clutch, unlike a general automatic transmission which employs a torque converter and a wet type multiple disc clutch. The dry type clutch is difficult to cool when heated, and does not deliver power optimally when heated because its friction performance is significantly decreased when its temperature increases. At the same time, clutch slip continues to occur as a clutch fade out phenomenon, whereby a risk of failure of the clutch exists.

Therefore, mechanisms for protecting a clutch operate when the clutch temperature rises beyond a certain temperature, but the functions act to limit the driving performance of the vehicle, such that there is great importance given to not entering clutch high-temperature mode.

The foregoing is intended merely to aid in the understanding of the background of the present disclosure, and is not intended to mean that the present inventive concept falls within the purview of the related art that is already M known to those skilled in the art.

### SUMMARY

Accordingly, the present disclosure has been made in an effort to overcome the above problems occurring in the related art. The disclosure herein is directed to a control method for a vehicle capable of preventing an overheating phenomenon of a clutch by adjusting shifting patterns of a transmission or engine revolutions per minute (RPM) based on clutch temperature distribution.

The control method for a vehicle includes steps of calculating, by a controller, a clutch severity index based on clutch temperature distribution; and adjusting at least one of a shift pattern and an engine RPM in accordance with the clutch severity index.

The clutch temperature distribution may be a normal distribution of a clutch prediction temperature collected during vehicle driving.

The clutch severity index may be calculated in proportion to the clutch temperature distribution.

At the adjusting step, an up shift shifting pattern may be adjusted upward to be upshifted at higher speed compared to a conventional shifting pattern when the clutch severity index is higher.

At the adjusting step, a down shift shifting pattern may be adjusted upward to be downshifted at higher speed compared to a conventional shifting pattern when the clutch severity index is higher.

At the adjusting step, the engine RPM may be adjusted to be lower than a conventional engine RPM when the clutch severity index is higher.

According to the control method of a vehicle configured as described above, it is possible to predict severe degree of a clutch based on the clutch temperature distribution and prevent an overheating phenomenon of the clutch by adjusting shifting patterns or an engine RPM in accordance with the severe degree.

### BRIEF DESCRIPTION OF THE DRAWINGS

The above and other objects, features and other advantages of the present inventive concept will be more clearly understood from the following detailed description when taken in conjunction with the accompanying drawings, in which:

FIG. 1 is a flow chart showing a control method for a vehicle according to one embodiment in the disclosure;

FIG. 2 is a block diagram showing a control device for a vehicle according to the embodiment in the disclosure;

FIG. 3 is a graph showing a clutch temperature distribution according to the embodiment in the disclosure;

FIG. 4 is a graph showing clutch severity index according to the embodiment in the disclosure;

FIG. 5 is a graph showing shifting pattern adjustment according to the embodiment in the disclosure; and

FIG. 6 is a graph showing engine RPM adjustment according to the embodiment in the disclosure.

### DETAILED DESCRIPTION OF THE EMBODIMENTS

Hereinafter, a control method for a vehicle according to an embodiment in the disclosure will be described in detail with reference to the accompanying drawings.

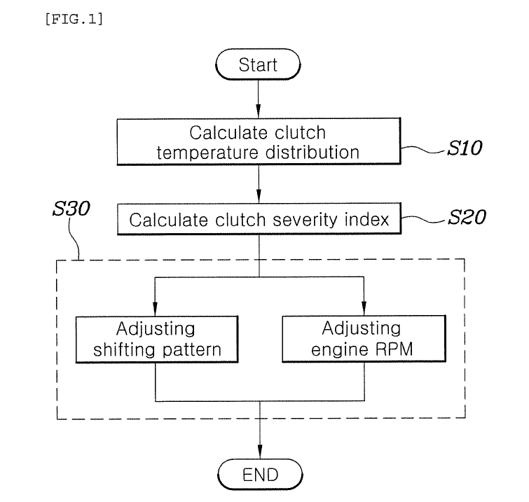

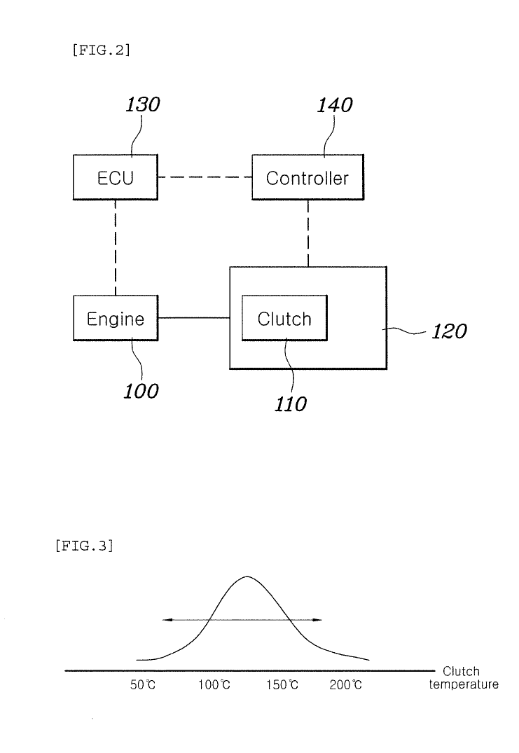

FIG. 1 is a flow chart showing a control method for a vehicle according to one embodiment in the disclosure. FIG. 2 is a block diagram showing a control device of a vehicle according to the embodiment in the disclosure. Referring to FIGS. 1 and 2, the control method for a vehicle may include a step of calculating, by a controller 140, a clutch severity index based on a clutch temperature distribution of a transmission 120 (S20); and a step of adjusting, by the controller 140, a shift pattern of the transmission 120 and/or an engine RPM in accordance with the clutch severity index (S30). The clutch 110 is included within the transmission 120.

Initially, the controller 140 may receive special values for predicting a temperature of a clutch 110 through an Engine Control Unit (ECU) 130 and a transmission 120, and so on, in order to calculate temperature distribution of the clutch 110. The temperature of the clutch 110 may be predicted, by the controller 140, utilizing any known formula relating to RPM, torque, slip amount and slip speed of the clutch 110. The temperature prediction methods of the clutch 110 have been variously proposed in the related art, and a detailed description thereto will be omitted.

The distribution of clutch temperatures may be a normal distribution based on the clutch prediction temperatures collected during vehicle driving. That is, the controller 140 may calculate the clutch temperature distribution by using the prediction temperatures of the clutch 110 collected during vehicle driving to generate the normal distribution S10. Thus, if it is determined that a driver's driving tendency is rough, and a vehicle mostly travels on inclined roads, the calculated values for the clutch temperature distribution will be larger. In contrast, if it is determined that a driver's driving tendency is closer to fuel economy driving, and a vehicle mostly travels on level road, the calculated values for the clutch temperature distribution will be lower.

In this way, the clutch temperature distribution may serve as an index indirectly representing the degree of the severity of the clutch according to the driver's driving tendency and road conditions during vehicle driving. Therefore, the controller 140 may calculate a clutch severity index in proportion to a clutch temperature distribution.

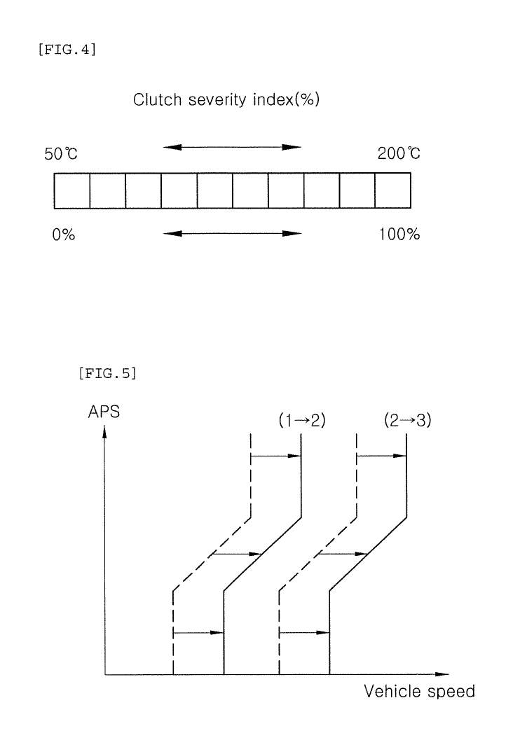

The clutch severity index may be an index representing the severity degree of the clutch 110 as a percentage. FIG. 3 is a graph showing a clutch temperature distribution according to an embodiment in the disclosureand FIG. 4 is a graph showing the corresponding clutch severity index. Referring to FIG. 3, the regular distribution values for the clutch temperatures may be calculated by collecting a prediction temperature of each of multiple clutches during vehicle driving and making the collected clutch prediction temperatures a normal distribution. It is possible to calculate the clutch severity index as a percentage index in proportion to the regular distribution values for the clutch temperatures calculated above. The clutch severity index may be the regular distribution values of the clutch temperatures divided by the reference value and multiplied by one hundred.

The controller 140 may prevent overheating of the clutch by adjusting shifting pattern based on the calculated clutch severity index. More concretely, at the adjusting step (S30), the controller 140 is able to adjust the shifting pattern to an up shifting pattern at higher vehicle speed compared to a conventional shifting pattern when the clutch severity index is higher.

That is, the time when shifting is made is delayed even if the vehicle speed increases if the clutch severity index is higher. Therefore, the slip amount increase of the clutch 110 can be prevented by keeping the up shift from being rapidly performed as the vehicle speed increases, so that up shifting does not occur as rapidly.

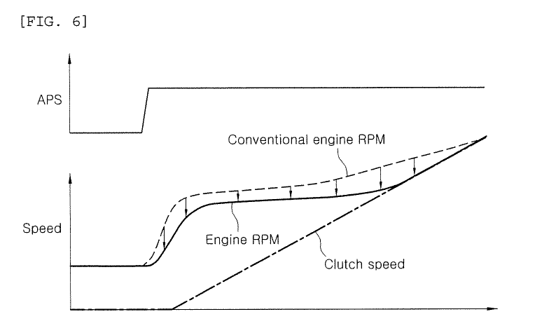

FIG. 5 is a graph showing shifting pattern adjustment according to an embodiment in the disclosure. The shifting pattern shown as dotted line is a conventional shifting pattern and the shifting pattern shown as solid line means the adjusted shifting pattern. It can be seen that the shifting pattern is adjusted up as the clutch severity index increases. Also, it can be seen that all of the 1→2 up shifting pattern and the 2→3 up shifting pattern are adjusted to higher vehicle speed. Furthermore, the up shifting patterns not shown in FIG. 5 may also be adjusted upward.

Further, the feature of adjusting the shifting pattern up in order for the shifting pattern to be downshifted at high speed compared to the conventional shifting pattern as the clutch severity index is higher at the adjusting step (S30).

That is, since a driver may rapidly accelerate or decelerate a vehicle frequently when the clutch severity index is higher, it is advantageous to drive an engine 100 in a mainly high torque state. For example, if a driver rapidly accelerates a vehicle, kick down shifting, where the shifting stage is shifted to a lower stage with opening degree of Accelerator Position Sensor (APS) and the vehicle speed increasing, may occur. However, it is possible to reduce the frequency of kick down shifting if the down shift shifting pattern is adjusted upward, thereby reducing the clutch slip amount due to kick down shifting.

Therefore, it is possible to minimize the phenomenon where the clutch 100 is slipped when heated in severe environments by adjusting the up shift shifting pattern and the down shift shifting pattern upward when the clutch severity index is higher.

Meanwhile, at the adjusting step (S30), if the clutch severity index becomes high, the ECU 130 may adjust the engine RPM to be lower than the conventional engine RPM, so that the fuel amount, air amount and air-fuel ratio are adjusted. This is a method of reducing the slip amount of the clutch 110 when the vehicle is starting in another exemplary embodiment in the disclosure.

FIG. 6 is a graph showing engine RPM adjustment according to an embodiment in the disclosure. Referring to FIG. 6, the engine RPM and the clutch speed increase as the opening degree of the APS increases, and the area between the engine RPM line and the clutch speed line may be referred to as a slip amount in the graph.

It is possible to reduce the speed difference with respect to the clutch speed by reducing the engine RPM from the conventional engine RPM shown by the dotted line when the clutch severity index is higher. This may minimize the slip amount occurring at the clutch 100 by coupling the engine 100 and the clutch 110, thereby minimizing the heating of the clutch 100. In the above, the controller 140 may be a transmission control unit.

According to the control method for a vehicle comprising the above-described structure, it is possible to generate a clutch severity index based on a prediction temperature of a clutch, and prevent an overheating phenomenon of the clutch by adjusting shifting patterns or engine RPM in accordance with the clutch severity index.

Although a preferred embodiment in the disclosure has been described for illustrative purposes, those skilled in the art will appreciate that various modifications, additions and substitutions are possible, without departing from the scope and spirit of the inventive concept as disclosed in the accompanying claims.

What is claimed is:

1. A control method for a vehicle, the control method comprising steps of:
calculating, by a controller, a clutch severity index based on a clutch temperature distribution; and
adjusting, by the controller, at least one of a shift pattern of the transmission and an engine RPM based on the clutch severity index.

2. The control method for a vehicle according to claim 1, wherein the clutch temperature distribution is a normal distribution based on a clutch prediction temperature determined during vehicle driving.

3. The control method for a vehicle according to claim 1, wherein the clutch severity index is calculated by the controller with reference to the clutch temperature distribution.

4. The control method for a vehicle according to claim 1, wherein, at the adjusting step, an up shift shifting pattern is adjusted, by the controller, upward to be upshifted at a higher speed compared to a conventional shifting pattern when the clutch severity index is high.

5. The control method for a vehicle according to claim 1, wherein, at the adjusting step, a down shift shifting pattern is adjusted, the controller, upward to be downshifted at a higher speed compared to a conventional shifting pattern when the clutch severity index is high.

6. The control method for a vehicle according to claim 1, wherein, at the adjusting step, the engine RPM is adjusted, by the controller, to be lower than a conventional engine RPM when the clutch severity index is high.
